(19) United States
(12) Patent Application Publication
(10) Pub. No.: US 2026/0289999 A1
(43) Pub. Date: Sep. 24, 2026

(54) IMAGE RECOGNITION DEVICE AND IMAGE RECOGNITION METHOD

(71) Applicant: DENSO CORPORATION, Kariya-city (JP)

(72) Inventors: Hiroaki IGARASHI, Kariya-city (JP); Kenichi YONEJI, Kariya-city (JP); Ikuro SATO, Tokyo (JP); Kohta ISHIKAWA, Tokyo (JP); Teppei SUZUKI, Tokyo (JP); Yusuke SEKIKAWA, Tokyo (JP); Mitsuru AMBAI, Tokyo (JP)

(21) Appl. No.: 19/687,187

(22) Filed: May 26, 2026

Related U.S. Application Data
(63) Continuation of application No. PCT/JP2025/001345, filed on Jan. 17, 2025.

(30) Foreign Application Priority Data
Feb. 1, 2024 (JP) 2024-014409

(51) Int. Cl. G06V 10/96; G06V 10/764; G06V 10/82; G06V 20/56; G06V 20/58

(52) U.S. Cl. CPC G06V 10/96; G06V 10/764; G06V 10/82; G06V 20/58; G06V 20/588

(57) ABSTRACT

An image recognition device includes: a detector capable of multitasking to execute image recognition tasks on a peripheral image, and capable of adjusting processing contents of the image recognition tasks; and a controller to adjust the processing contents of the image recognition tasks in the detector. The controller receives a peripheral image as an input and dynamically changes the processing contents of the image recognition tasks in the detector in response to a tendency of contents of the peripheral image.

### CROSS REFERENCE TO RELATED APPLICATION

The present application is a continuation application of International Patent Application No. PCT/JP2025/001345 filed on January 17, 2025, which designated the U.S. and claims the benefit of priority from Japanese Patent Application No. 2024-014409 filed on February 1, 2024. The entire disclosures of all of the above applications are incorporated herein by reference.

### TECHNICAL FIELD

The present disclosure relates to an image recognition device and an image recognition method.

### BACKGROUND

A technique for detecting an object from input image data uses three detectors with different detection accuracies or speeds. The controller selects one of the three detectors for each frame of image data to perform object detection. In the technique, the controller selects one of three detectors according to the data load, which is information indicating the amount of image data to be processed. The controller frequently selects a faster detector when the data load is heavy and frequently selects a more accurate detector when the data load is light.

### SUMMARY

According to an aspect of the present disclosure, an image recognition device includes: an image processor capable of multitasking to execute a plurality of image recognition tasks on an image and capable of adjusting processing contents of the image recognition tasks; and a controller configured to adjust the processing contents of the image recognition tasks in the image processor. The controller is configured to receive the image as an input and dynamically change the processing contents of the image recognition tasks in the image processor in response to a tendency of contents of the image. The controller has a scene classification unit to receive the image as an input and classifies scenes indicated by the image. The controller is configured to dynamically change the processing contents of the image recognition tasks in the image processor in response to the scenes classified by the scene classification unit as the tendency of contents of the image. The controller may further have a first uncertainty prediction unit to predict uncertainty of the scenes classified by the scene classification unit. The controller may be configured to dynamically change the processing contents of the image recognition tasks in the image processor using the uncertainty predicted by the first uncertainty prediction unit.

### BRIEF DESCRIPTION OF DRAWINGS

FIG. 1 is a diagram illustrating an example of a schematic configuration of an image recognition system.

FIG. 2 is a diagram illustrating an example of a schematic configuration of an image recognition device according to a first embodiment.

FIG. 3 is a diagram for explaining an example of a learning method for a controller unit.

FIG. 4 is a diagram for explaining an example in which NW structure cannot be dynamically changed in a detector.

FIG. 5 is a diagram for explaining an example in which NW structure can be dynamically changed in a detector.

FIG. 6 is a diagram illustrating an example of a schematic configuration of an image recognition device according to a second embodiment.

FIG. 7 is a diagram illustrating an example of a schematic configuration of an image recognition device according to a third embodiment.

### DETAILED DESCRIPTION

A technique for detecting an object from input image data uses three detectors with different detection accuracies or speeds. The controller selects one of the three detectors for each frame of image data to perform object detection. In the technique, the controller selects one of three detectors according to the data load, which is information indicating the amount of image data to be processed. The controller frequently selects a faster detector when the data load is heavy and frequently selects a more accurate detector when the data load is light.

However, issues to be considered are thought to arise when multitasking is performed in which a detector is responsible for a task of multiple image recognitions (hereinafter referred to as image recognition tasks). The details will be described as follows.

Image recognition tasks can be easy or difficult depending on the scene the image depicts. Further, the necessity of each of the image recognition tasks may differ depending on the scene shown in the image. Therefore, when multitasking is performed, it is preferable to change the degree of priority given to the processing accuracy or speed of each image recognition task depending on the scene shown in the image. In contrast, the technology disclosed in Patent Document 1 only allows a detector with different detection accuracy or speed to be selected according to the data load, which is information indicating the amount of image data. Therefore, when multitasking is performed, it is difficult to perform plural image recognition tasks with a more preferable balance between processing accuracy and processing speed depending on the scene.

One object of this disclosure is to provide an image recognition device and an image recognition method that more easily enable image recognition tasks to be performed with a more desirable balance between accuracy and speed depending on the scene.

In order to achieve the above-mentioned object, an image recognition device of the present disclosure includes: an image processing unit that is capable of multitasking to perform multiple image recognition tasks on an image, and that is capable of adjusting the processing contents of the image recognition tasks; and a controller unit that adjusts the processing contents of the image recognition tasks in the image processing unit. The controller unit takes an image as input and dynamically changes the processing contents of the image recognition tasks in the image processing unit depending on the tendency of contents of the image.

In order to achieve the above object, an image recognition method of the present disclosure, executed by at least one processor, includes: an image processing step which is capable of multitasking processing in which image recognition tasks are performed on an image and is capable of adjusting the processing contents of the image recognition tasks; and a controller step to adjust the processing contents of the image recognition tasks in the image processing step. The controller step takes an image as input and dynamically changes the processing contents of the image recognition tasks in the image processing step according to the tendency of contents of the image.

According to the above configuration, the contents of multitasking, to execute the plural image recognition tasks on an image, can be dynamically changed according to the tendency of contents of the image. Therefore, it becomes possible to dynamically change the balance between the processing speed and processing accuracy of the image recognition tasks depending on the scene represented by the image contents. As a result, it becomes easier to perform image recognition tasks with a more desirable balance between accuracy and speed depending on the scene.

Embodiments will be described for disclosure hereinafter with reference to the drawings. For convenience of explanation, portions having the same functions as those illustrated in the drawings used in the description among embodiments are assigned the same reference symbol, and descriptions of the same portions may be omitted. Description in another applicable embodiment may be referred to for such a portion denoted by the identical reference sign.

### First Embodiment

### General configuration of Image recognition system 1

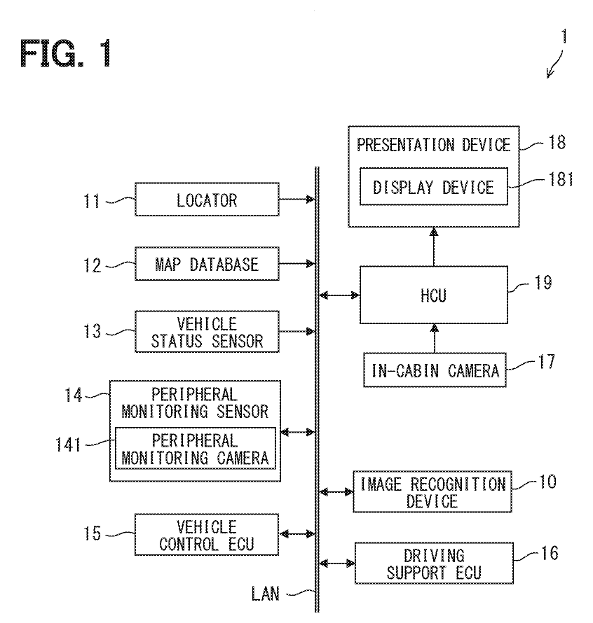

Hereinafter, a first embodiment of the present disclosure will be described with reference to the drawings. The image recognition system 1 shown in FIG. 1 can be used in a vehicle. As shown in FIG. 1, the image recognition system 1 includes an image recognition device 10, a locator 11, a map database (hereinafter referred to as a map DB) 12, a vehicle status sensor 13, a peripheral monitoring sensor 14, a vehicle control ECU 15, a driving support ECU 16, an in-cabin camera 17, a presentation device 18, and an HCU (Human Machine Interface Control Unit) 19. For example, the image recognition device 10, the locator 11, the map DB 12, the vehicle status sensor 13, the peripheral monitoring sensor 14, the vehicle control ECU 15, the driving support ECU 16, and the HCU 20 may be connected to an in-vehicle LAN (see LAN in FIG. 1). Although the vehicle using the image recognition system 1 is not necessarily limited to an automobile, the following description will be given taking the case of using the image recognition system 1 in an automobile as an example.

A vehicle using the image recognition system 1 may be a vehicle capable of autonomous driving (hereinafter referred to as an autonomous driving vehicle). There may be multiple stages (hereinafter, referred to as automation levels) of automated driving of an automated driving vehicle, for example, as defined by SAE. The automation levels are classified into, for example, five levels including LV0 to LV5 as follows. The LV0 is a level where a driver performs all driving tasks without system intervention. The driving task may be rephrased as a dynamic driving task. The driving task includes, for example, steering, acceleration/deceleration, and surrounding monitoring. The LV0 corresponds to so-called manual driving. The LV1 is a level where the system assists steering or acceleration/deceleration. The LV1 corresponds to so-called driving assistance. The LV2 is a level where the system assists both steering and acceleration/deceleration. The LV2 corresponds to so-called partial driving automation. The LV1 and the LV2 are also part of automated driving. The LV3 of the automated driving is a level where the system performs all driving tasks under certain conditions, and the driver performs the driving operation in an emergency situation. The LV4 of the automated driving is a level where the system is capable of executing all driving tasks, except under a specific circumstance, such as an unexpected road condition, an extreme environment, and the like. The LV4 corresponds to a high driving automation. The LV5 of the automated driving is a level in which the system is capable of executing all driving tasks in any situation. The LV5 corresponds to a full driving automation. In the following, an example will be described in which the vehicle using the image recognition system 1 has an automation level of at least LV1 or higher.

The locator 11 includes a GNSS (Global Navigation Satellite System) receiver and an inertial sensor. The GNSS receiver receives positioning signals from positioning satellites. The inertial sensor includes, for example, a gyro sensor and an acceleration sensor. The locator 11 combines the positioning signals received by the GNSS receiver with a measurement result of the inertial sensor to successively detect the position of the host vehicle (hereinafter, a host vehicle position). The host vehicle position may be represented by, for example, coordinates of latitude and longitude. The host vehicle position may be measured based on also a travel distance obtained from signals sequentially output from a vehicle speed sensor mounted on the vehicle.

The map DB 12 is a non-volatile memory that stores map data used for route guidance by the navigation device. The map data used for route guidance includes link data, node data, and the like. The link data includes various pieces of data such as link ID identifying a link, a link length indicating a length of the link, a link azimuth, a link travel time, link shape information, node coordinates (latitude/longitude) of a start point and an end point of the link, and road attributes. The road attributes include the road name, road type, road width, and speed limit. The node data includes various pieces of data such as a node ID in which a unique number is assigned to each node on a map, node coordinates, a node name, a node type, a connection link ID in which a link ID of a link connected to the node is described, an intersection type, and the like. The map DB 12 may store high-precision map data. The high-precision map data is map data with higher precision than map data used for route guidance. The high-precision map data includes information that can be used for driving assistance, such as information on the three-dimensional shape of roads, information on the number of lanes, and information indicating the permitted direction of travel for each lane.

The vehicle status sensor 13 is a group of sensors for detecting various states of the vehicle. The vehicle status sensor 13 includes a vehicle speed sensor and the like. The vehicle speed sensor detects the speed of the host vehicle. The vehicle status sensor 13 outputs detected sensing information to the in-vehicle LAN. The sensing information detected by the vehicle status sensor 13 may be output to the in-vehicle LAN via an ECU mounted on the host vehicle.

The peripheral monitoring sensor 14 monitors surrounding environment of the host vehicle. The peripheral monitoring sensor 14 detects obstacles around the host vehicle, for example, moving objects such as pedestrians and other vehicles, and stationary objects such as fallen objects on the road. In addition, the peripheral monitoring sensor 14 detects a road marking such as a traveling lane marking around the host vehicle. The peripheral monitoring sensor 14 includes a peripheral monitoring camera 141. The peripheral monitoring camera 141 sequentially captures and outputs the captured images as sensing information. The captured images sequentially output from the peripheral monitoring camera 141 are specifically image data as captured image data. Hereinafter, the captured images sequentially output from the peripheral monitoring camera 141 will be referred to as periphery image data. The peripheral monitoring camera 141 may be plural cameras with different imaging ranges. The peripheral monitoring sensor 14 may include a search wave sensor in addition to the peripheral monitoring camera 141. Examples of the search wave sensor include millimeter wave radar, sonar, and LiDAR (Light Detection and Ranging / Laser Imaging Detection and Ranging). The search wave sensor sequentially outputs, as sensing information, scanning results based on received signals obtained when receiving waves reflected by an obstacle.

The vehicle control ECU 15 is an electronic control unit that executes traveling control of the host vehicle. The traveling control includes an acceleration/deceleration control and/or a steering control. The vehicle control ECU 15 includes a steering ECU that executes the steering control, a power unit control ECU and a brake ECU that execute the acceleration/deceleration control. The vehicle control ECU 15 executes the driving control by outputting control signals to each driving control device mounted on the vehicle. Examples of the driving control device include an electronic control throttle, a brake actuator, and an EPS (Electric Power Steering) motor.

The driving support ECU 16 is an electronic control unit that assists the driving of the vehicle. The driving support ECU 16 executes processes related to driving assistance based on signals input from the various in-vehicle devices described above. The driving support ECU 16 cooperates with the vehicle control ECU 15 to execute acceleration/deceleration control, steering control, and the like of the host vehicle. Examples of the driving support include adaptive cruise control (ACC), pre-collision safety (PCS), and automatic emergency braking (AEB).

The in-cabin camera 17 captures an image of a predetermined range in the cabin of the host vehicle. The in-cabin camera 17 captures an image of an area including at least the driver seat of the vehicle. The in-cabin camera 17 includes, for example, a near-infrared light source, a near-infrared camera unit, and a control unit that controls these components. The in-cabin camera 17 captures an image of the driver irradiated with near-infrared light by the near-infrared light source with the near-infrared camera. An image captured by the near-infrared camera is image-analyzed by the control unit. The control unit analyzes the captured image to detect the driver's facial orientation, line of sight, and other conditions. The in-cabin camera 17 sequentially outputs the detected state of the driver to the HCU 19.

The presentation device 18 is provided in the vehicle and presents information to the interior of the vehicle. That is, the presentation device 18 presents information to the driver of the vehicle. The presentation device 18 performs the information presentation according to an instruction from the HCU 19. The presentation device 18 includes a display device 181. The display device 181 presents information by displaying the information. The display device 181 may be a meter MID (Multi Information Display), CID (Center Information Display), or HUD (Head-Up Display). The meter MID is a display device located in front of the driver seat in the cabin. As an example, the meter MID may be arranged on the meter panel. The CID is a display device disposed at a center of an instrument panel of the host vehicle. The HUD is provided, for example, on an instrument panel in the cabin of the host vehicle. The HUD projects a display image formed by a projector onto a predetermined projection area of the front windshield, which serves as a projection member. The HUD may also be configured to project the display image onto a combiner provided in front of the driver seat, instead of the front windshield. The presentation device 18 may include an audio output device that presents information by outputting sound.

The HCU 19 is an electronic control unit that executes various processes related to interactions between the occupant and the systems of the vehicle. The HCU 19 causes the presentation device 18 to present information. The HCU 19 acquires the driver's state detected by the in-cabin camera 17. The HCU 20 may identify the driver's condition from an image captured by the in-cabin camera 17. In other words, the HCU 19 may take on part of the functions of the control unit of the in-cabin camera 17.

The image recognition device 10 is mainly composed of a computer including, for example, a processor, a volatile memory, a non-volatile memory, an I/O, and a bus connecting these. The image recognition device 10 executes a control program stored in non-volatile memory to perform processing related to image recognition. The image recognition device 10 executes a task (hereinafter referred to as an image recognition task) on an image captured by the peripheral monitoring camera 141, and recognizes an object according to the image recognition task. For example, when the image recognition task is semantic segmentation, class identification is performed and regions on the image are segmented by class. In this case, the classes are semantic units, such as "road," "person," and "bicycle." When the image recognition task is to detect a traffic light, the color of the traffic light, the flashing state, etc. of the traffic light are recognized. When the image recognition task is branch path detection, the branch paths are recognized. The image recognition task may be to recognize something other than those mentioned above from an image. The image recognition device 10 performs plural image recognition tasks. That is, the image recognition device 10 performs multitasking processing. The configuration of the image recognition device 10 will be described in detail below.

### General configuration of Image recognition device 10

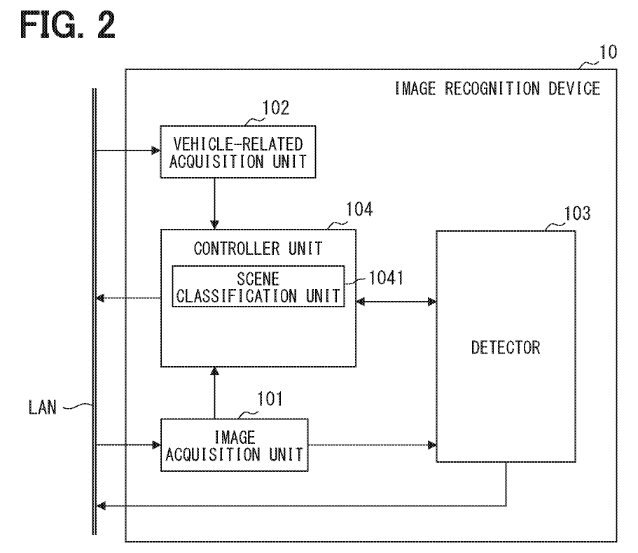

Next, the schematic configuration of the image recognition device 10 will be described with reference to FIG. 2. As shown in FIG. 2, the image recognition device 10 includes an image acquisition unit 101, a vehicle-related acquisition unit 102, a detector 103, and a controller unit 104 as functional blocks. Furthermore, the execution of the processing of each functional block of the image recognition device 10 by a computer corresponds to the execution of an image recognition method. Some or all of the functions executed by the image recognition device 10 may be configured as hardware using one or more ICs or the like. In addition, some or all of the functional blocks of the image recognition device 10 may be realized by a combination of software executed by a processor and hardware components.

The image acquisition unit 101 acquires surrounding image data sequentially output from the peripheral monitoring camera 141. In this embodiment, data of surrounding image captured by the peripheral monitoring camera 141 is used for image recognition, but not necessarily limited to this. For example, the sensing results detected by other peripheral monitoring sensor 14 that can be used for image recognition, such as LiDAR, may be used for image recognition. In this case, the sensing results may also be included in the surrounding image data. The vehicle-related acquisition unit 102 acquires information related to the vehicle (hereinafter referred to as vehicle-related information) other than the surrounding image data. The vehicle-related information includes information on the vehicle speed, map information, driver status information, sensor characteristic information, and the like. Information about the speed of the vehicle itself will be referred to as vehicle speed information hereinafter.

The vehicle-related acquisition unit 102 may acquire the vehicle speed information from a vehicle speed sensor of the vehicle status sensors 13. The vehicle-related acquisition unit 102 may acquire map information from the map DB 12. The vehicle-related acquisition unit 102 may acquire map information limited to the vicinity of the vehicle position measured by the locator 11. The vehicle-related acquisition unit 102 acquires the driver's condition from the HCU 19. The driver's condition may be determined by, for example, acquiring the line of sight direction detected by the in-cabin camera 17. The vehicle-related acquisition unit 102 may acquire the sensor characteristics from the peripheral monitoring sensor 14. The nonvolatile memory of the peripheral monitoring sensor 14 may store in advance the sensor characteristics of each sensor included in the peripheral monitoring sensor 14. For example, the sensor characteristics may be data indicating the unsuitable objects and unsuitable situations for each sensor included in the peripheral monitoring sensor 14. The term unsuitable object refers to an object that is difficult to detect due to the characteristics of the detection principle of the sensor. The unsuitable situation indicates a situation in which object detection performance may deteriorate. The object that is difficult to detect may include an object that is likely to be mistaken for another type of object, or an object for which the detection result is unstable.

The detector 103 executes plural image recognition tasks on the surrounding images acquired by the image acquisition unit 101. In other words, the detector 103 is capable of multitasking the peripheral images acquired by the image acquisition unit 101. The detector 103 corresponds to an image processing unit. The processing in the detector 103 corresponds to an image processing step. The detector 103 executes plural image recognition tasks on the peripheral image, thereby recognizing a recognition target for each image recognition task from the peripheral image. This recognition can also be called detection.

The detector 103 may perform plural image recognition tasks using a machine learning model. The machine learning model is a model generated by performing machine learning so as to input peripheral images and output recognition targets for multiple image recognition tasks. The detector 103 may execute plural image recognition tasks using a neural network (hereinafter, referred to as NN) of the machine learning models. The detector 103 may execute plural image recognition tasks using a machine learning model other than a network structure such as a neural network. For example, a random forest, which is a tree-structured machine learning model, may be used. In the following, the explanation will be continued by taking a case where the NN is used as the detector 103. The detector 103 is capable of dynamically changing the processing contents of the image recognition tasks. In this embodiment, the detector 103 is capable of dynamically changing the network structure and parameters of the NN. The parameters are, for example, at least one of the weights and biases of each layer in a neural network. In this embodiment, the processing contents of the image recognition tasks correspond to the network structure and weights of the NN.

The controller unit 104 adjusts the processing contents of the image recognition tasks in the detector 103. The controller unit 104 receives a peripheral image as an input and dynamically changes the processing contents of the image recognition tasks in the detector 103 according to the tendency of the contents of the peripheral image. The peripheral image input to the controller unit 104 may be the peripheral image acquired by the image acquisition unit 101. The processing in the controller unit 104 corresponds to a controller step.

According to the above configuration, the contents of the multitasking process to execute the image recognition tasks on a peripheral image can be dynamically changed according to the tendency of the contents of the image. The tendency of the contents of the peripheral image is highly correlated with the scene indicated by the contents of the peripheral image. Therefore, it becomes possible to dynamically change the balance between the processing speed and accuracy of the image recognition tasks depending on the scene represented by the image contents. As a result, it becomes easier to perform image recognition tasks with a more desirable balance between accuracy and speed depending on the scene. The controller unit 104 may dynamically change the processing contents of the multiple image recognition tasks in the detector 103 by changing at least one of the network structure and parameters of the NN.

Furthermore, with the above configuration, the processing content of the image recognition task is automatically switched for the peripheral image, so that the processing time margin required when designing the detector 103 can be eliminated. Therefore, when the processing accuracy is fixed, faster recognition processing is achieved. In addition, as a secondary effect, power consumption is reduced. In addition, the processing content of the image recognition task automatically switches depending on the surrounding image, reducing unimportant processing and allowing more time to be spent on important processing. Therefore, when the processing time is fixed, a more accurate recognition process can be achieved.

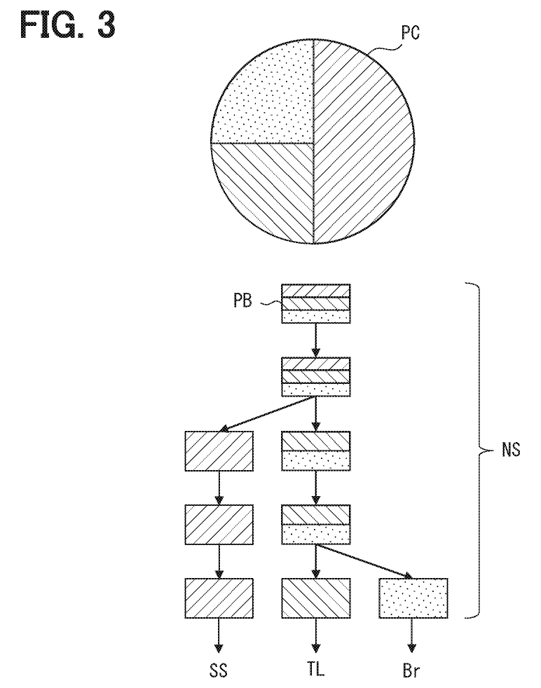

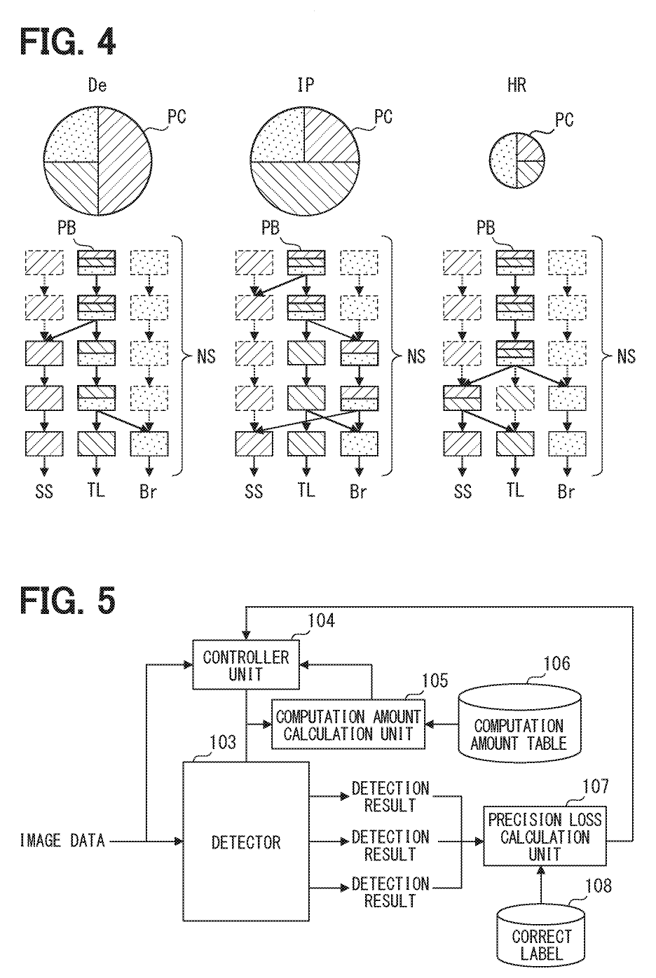

The above-mentioned effects will now be described with reference to FIGS. 3 and 4. FIG. 3 is a diagram for explaining an example of case where the content of multitasking cannot be dynamically changed. FIG. 4 is a diagram for explaining an example in which the content of multitask processing can be dynamically changed. In FIGS. 3 and 4, semantic segmentation, traffic light detection, and road branch detection are performed as the image recognition tasks in multitask processing. The SS in FIGS. 3 and 4 shows the semantic segmentation of the image recognition tasks. The TL in FIG. 3 and FIG. 4 shows traffic light detection among the image recognition tasks. The Br in FIG. 3 and FIG. 4 shows branch path detection among the image recognition tasks. The PC in FIG. 3 and FIG. 4 schematically shows the balance of performance and the amount of calculation for the image recognition tasks. The performance referred to here can be rephrased as processing accuracy. The proportion of each patterned area of the PC indicates the balance of performance in the image recognition tasks. The size of the PC indicates the total amount of calculations for the image recognition tasks. This amount of calculation affects the processing speed of the image recognition task. The NS in FIG. 3 and FIG. 4 indicates the network structure of the NN. The PB in FIG. 3 and FIG. 4 indicates the processing block of the NN. In FIG. 4, De, IP, and HR indicate different scenes. The De is the default scene. The IP is assumed to be a scene of driving at an intersection. The HR is a scene of driving on a highway. In FIG. 4, the default scene may be neither intersection driving nor highway driving. In FIG. 4, unused processing blocks are indicated by dashed lines, and used processing blocks are indicated by solid lines.

As shown in FIG. 3, when the content of multitask processing cannot be dynamically changed, the processing speed and processing accuracy of the image recognition tasks cannot be changed regardless of the scene. On the other hand, as shown in FIG. 4, when the content of multitask processing can be dynamically changed, the processing speed and processing accuracy of the image recognition tasks can be changed depending on the scene. For example, in case of a scene of driving at an intersection, it becomes possible to improve the processing accuracy of semantic segmentation and traffic light detection, which are considered to be more necessary for driving at an intersection, in preference to branch road detection. In the case of scene of driving on a highway, as shown in FIG. 4, it is possible to prioritize and improve the processing accuracy of semantic segmentation and branch road detection over the processing accuracy of traffic light detection, which is considered less necessary for driving on a highway. In the case of scene of driving on a highway, where there is little external disturbance, it is possible to change the processing speed of the image recognition tasks so that the overall amount of calculation is reduced compared to other scenes.

The controller unit 104 may change the processing speed and processing accuracy of the image recognition tasks according to the scene using a machine learning model. The machine learning model can learn the NN network structure and parameters that balance the processing speed and processing accuracy of the image recognition tasks according to the tendency in the content of the surrounding images. This learning can be performed to minimize the loss of accuracy calculated from the detection results of each image recognition task and the amount of calculation calculated from the network configuration. This machine learning model may be realized by a hypernetwork such as a convolutional neural network (CNN).

With reference to FIG. 5, learning will be described to minimize the loss of accuracy calculated from the detection results of each image recognition task and the amount of calculation calculated from the network configuration. FIG. 5 is a diagram for explaining an example of learning by the controller unit 104. In FIG. 5, the computation amount calculation unit 105, the computation amount table 106, the precision loss calculation unit 107, and the correct label 108 may be provided as functional blocks in the image recognition device 10.

The computation amount calculation unit 105 calculates the computational complexity for the NN of the detector 103 generated by the controller unit 104. The computation amount calculation unit 105 refers to the computation amount table 106 to calculate the computation amount. The computation amount table 106 may be a database that stores in advance the computation amount for each unit such as a node or edge of a network structure. This amount of computation can also be rephrased as the amount of calculation for each layer of the neural network. The amount of computation may include the amount of data communication between hardware. The computation amount table 106 may be realized using, for example, a nonvolatile memory. The computation amount calculation unit 105 may calculate the computation amount of the NN by referring to the computation amount table 106 and adding up the computation amounts for each unit constituting the network structure for which the computation amount is to be calculated.

The precision loss calculation unit 107 calculates the precision loss in recognition using the NN of the detector 103 from the detection result of the detector 103. The precision loss calculation unit 107 calculates the precision loss by referring to the correct label 108. The correct label 108 may be a database that stores in advance the correct recognition results for each surrounding image used for learning. The precision loss calculation unit 107 may refer to the correct label 108 and calculate the precision loss depending on how accurate the detection result of the detector 103 was.

In the learning example shown in FIG. 5, the amount of computation and loss of accuracy of the NN are calculated while changing the network structure and parameters of the NN of the detector 103 generated by the controller unit 104. Then, the network structure and parameters that minimize the amount of computation and loss of accuracy of the neural network are learned according to the tendency of the content of the surrounding images used for learning. This allows the controller unit 104 to generate a NN network structure and parameters that can balance the processing speed and processing accuracy of the image recognition task according to the tendency of the content of the surrounding image.

The controller unit 104 may dynamically change the processing content of the image recognition tasks in the detector 103 depending on the tendency in the content of the surrounding images so as to maximize the processing accuracy of each of the image recognition tasks within the given processing time constraints. This can be achieved by using the learning results of learning the processing content of the image recognition tasks that maximizes the processing accuracy of each of the image recognition tasks within the given processing time constraints, depending on the tendency in the content of the surrounding images. This makes it easier to perform the image recognition tasks in a way that maximizes the processing accuracy of each of the tasks within a given processing time constraint, depending on the scene.

The controller unit 104 may dynamically change the processing content of the image recognition tasks in the detector 103 according to the tendency in the content of the surrounding images so that the sum of the processing speeds of each of the image recognition tasks is minimized within the given processing accuracy constraints. This can be achieved by using the learning results of learning the processing content of the image recognition tasks that minimizes the sum of the processing speeds of the image recognition tasks within given processing accuracy constraints, depending on the tendency in the content of the surrounding images. This makes it easier to perform the image recognition tasks in a way that minimizes the sum of the processing speeds of the image recognition tasks for a given processing speed constraint, depending on the scene.

The controller unit 104 may dynamically change the processing content of the image recognition tasks in the detector 103 depending on the tendency in the content of the surrounding images so that the total amount of hardware resource usage for each of the image recognition tasks is minimized within the given processing accuracy constraints. This can be achieved by using the learning results of learning the processing content of the image recognition tasks that minimizes the total hardware resource usage of each of the image recognition tasks within given processing accuracy constraints, depending on the tendency in the content of surrounding images. This makes it easier to perform the image recognition tasks in a way that minimizes the total amount of hardware resources used by each of the image recognition tasks for a given processing accuracy constraint, depending on the scene. The hardware resource may be, for example, a memory. The hardware resources may include a processor, storage, and the like.

The controller unit 104 preferably has a scene classification unit 1041 as a sub-functional block. The scene classification unit 1041 may be provided separately from the controller unit 104. The scene classification unit 1041 receives a peripheral image as input and classifies the scene indicated by the content of the peripheral image. It is preferable that the controller unit 104 dynamically changes the processing contents of the multiple image recognition tasks in the detector 103 according to the scene classified by the scene classification unit 1041 as a tendency of the content of the surrounding image. This makes it possible to perform image recognition tasks with a more accurate balance between accuracy and speed depending on the scene. The scene classification unit 1041 may be rule-based or learning-based. In the case of learning-based detection, a machine learning model can be used to classify scenes from surrounding images. As the machine learning model, for example, the NN that has been trained to classify scenes from surrounding images may be used. Examples of scenes that can be classified include highways, parking lots, and areas around intersections.

The controller unit 104 may be configured to perform processing in response to input other than the peripheral image. Examples of inputs other than the peripheral image include vehicle-related information and time-series information acquired by the vehicle-related acquisition unit 102. The time-series information may be the detection result of the detector 103 for the peripheral image of the previous frame. The controller unit 104 may also use vehicle-related information and time-series information to dynamically change the processing contents of the multiple image recognition tasks in the detector 103. The controller unit 104 may dynamically change the processing contents of the image recognition tasks in the detector 103 in accordance with the vehicle-related information and time-series information. In this case, the controller unit 104 can dynamically change the processing content of the image recognition tasks in the detector 103 based on the learning results of learning the balance of processing of the image recognition tasks in accordance with vehicle-related information and time-series information.

The controller unit 104 may dynamically change the processing contents of the multiple image recognition tasks in the detector 103 in accordance with the vehicle speed information acquired by the vehicle-related acquisition unit 102. For example, the controller unit 104 may change the processing speed of the image recognition tasks so as to be faster as the vehicle speed increases than when the vehicle speed is slower. The faster the vehicle speed, the greater the change in the surrounding image in a short period of time, and therefore the faster the processing speed is required. The above configuration makes it easy to meet this demand.

The controller unit 104 preferably uses map information acquired by the vehicle-related acquisition unit 102. For example, the controller unit 104 may use map information to reinforce or correct the scene classification performed by the scene classification unit 1041. According to the above configuration, it is possible to perform an image recognition task with a more preferable balance between accuracy and speed depending on the scene, with even greater accuracy.

The controller unit 104 may dynamically change the processing contents of the multiple image recognition tasks in the detector 103 in accordance with the state of the driver acquired by the vehicle-related acquisition unit 102. The controller unit 104 may change the image recognition task in a direction away from the driver's line of sight, for example, so as to increase the processing accuracy. For example, when the line of sight is to the right, the processing accuracy of the image recognition task for recognizing objects to the left and in front can be changed to be higher. In addition, when performing the image recognition using the detector 103 according to the imaging direction, the processing contents of the image recognition tasks can be changed to improve processing accuracy for peripheral images in directions other than those in which the driver's line of sight is directed. According to the above configuration, it is possible to prioritize increasing the accuracy of image recognition in areas where the driver is not gazing, making it easier to leave driving assistance to the system of the vehicle itself.

The controller unit 104 may dynamically change the processing contents of the multiple image recognition tasks in the detector 103 in accordance with the sensor characteristics acquired by the vehicle-related acquisition unit 102. For example, in a scene where the peripheral monitoring sensor 14 other than the peripheral monitoring camera 141 is not good at processing, the controller unit 104 may make changes to increase the processing accuracy of the image recognition tasks in the detector 103. The controller unit 104 may determine whether or not a scene falls under a weak situation based on the scene classified by the scene classification unit 1041 and the sensor characteristics. According to the above configuration, in sensor fusion, it becomes easier to compensate for the deterioration of the detection accuracy of the peripheral monitoring sensor 14 in a situation where the sensor fusion is not good at it.

The controller unit 104 may dynamically change the processing contents of the multiple image recognition tasks in the detector 103 in accordance with the time-series information. The controller unit 104 may dynamically change the processing contents of the multiple image recognition tasks in the detector 103 according to the detection results of the detector 103 for the peripheral image of the previous frame. The controller unit 104 may make changes depending on whether the detection result is estimated to be difficult to recognize or easy to recognize. Whether recognition is difficult or easy can be determined by the number of recognition objects, such as pedestrians and cars. If the detection result indicates that recognition is likely to be difficult, the controller unit 104 may change the processing content of the image recognition tasks to those suitable for cases where recognition is likely to be difficult. The controller unit 104 may learn the processing contents of the image recognition tasks according to the difficulty of recognition through machine learning. According to the above configuration, it is possible to perform processing of an image recognition task that is appropriate for the difficulty of the image recognition.

Additionally, the controller unit 104 may turn off unnecessary image recognition tasks depending on the scene. For example, on a highway where pedestrians are not expected to be present, the image recognition task for detecting pedestrians may be turned off.

The controller unit 104 may perform processing related to the output other than the control of the detector 103. An example of this process is described below. When the processing load of the detector 103 reaches or exceeds a specified value, the controller unit 104 may request the driver to decelerate or may perform deceleration control. According to this, the processing load on the detector 103 can be reduced by decelerating the host vehicle. A case where the processing load of the detector 103 exceeds a specified value can be rephrased as a case where the machine learning model of the detector 103 controlled by the controller unit 104 can no longer satisfy the constraints of processing time and processing accuracy imposed during learning. The deceleration request may be made by the presentation device 18. The deceleration control may be performed by the driving support ECU 16. When deceleration control is performed, the presentation device 18 may also present the reason for deceleration. This makes it possible to reduce the anxiety felt by the occupants of the vehicle regarding the deceleration control.

When the processing load of the controller unit 104 exceeds a specified value, the controller unit 104 may instruct the peripheral monitoring camera 141 to lengthen the image capturing period. This makes it possible to reduce the processing load on the controller unit 104. The controller unit 104 may change the imaging cycle of the peripheral monitoring camera 141 depending on the scene classified by the scene classification unit 1041. For example, in a simple scene with few disturbances, such as a highway, the peripheral monitoring camera 141 may be instructed to lengthen the image capturing period. On the other hand, in a scene where recognition processing is difficult, the peripheral monitoring camera 141 may be instructed to lengthen the image capturing cycle.

When the processing load of the controller unit 104 exceeds a specified value, the controller unit 104 may instruct the peripheral monitoring camera 141 to lower the resolution of the periphery image. This makes it possible to reduce the processing load on the controller unit 104. The controller unit 104 may change the resolution of the peripheral monitoring camera 141 depending on the scene classified by the scene classification unit 1041. For example, in a simple scene with few disturbances, such as on a highway, the peripheral monitoring camera 141 may be instructed to lower the resolution. On the other hand, in a scene where recognition processing is difficult, the peripheral monitoring camera 141 may be instructed to increase the resolution.

### Second Embodiment

The present disclosure is not limited to the configuration described in the above embodiment, but can also adopt the following configuration as a second embodiment. The followings will describe an example of a configuration of the second embodiment with reference to the accompanying drawings. The image recognition system 1 of the second embodiment is similar to the image recognition system 1 of the first embodiment, except that the image recognition system 1 of the second embodiment includes an image recognition device 10a instead of the image recognition device 10.

### General configuration of Image recognition device 10a

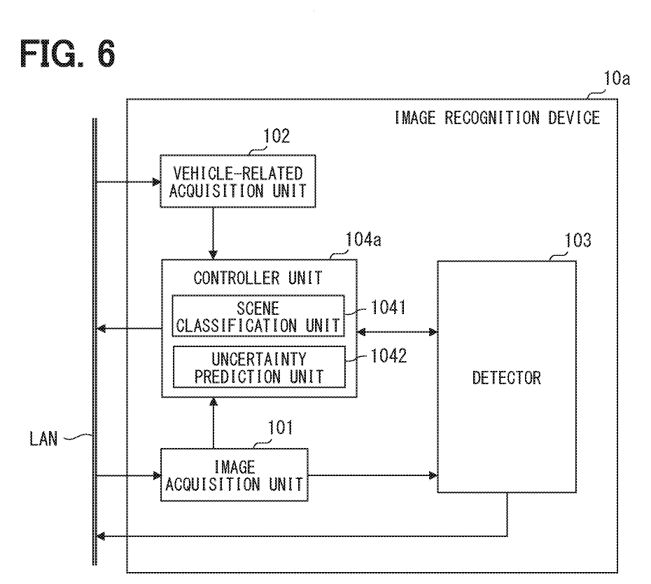

Next, the schematic configuration of the image recognition device 10a will be described with reference to FIG. 6. As shown in FIG. 6, the image recognition device 10a includes the image acquisition unit 101, the vehicle-related acquisition unit 102, the detector 103, and a controller unit 104a as functional blocks. The image recognition device 10a is similar to the image recognition device 10 of the first embodiment, except that the image recognition device 10a includes the controller unit 104a instead of the controller unit 104. Furthermore, the execution of the processing of each functional block of the image recognition device 10a by a computer corresponds to the execution of an image recognition method.

The controller unit 104a has the scene classification unit 1041 and an uncertainty prediction unit 1042 as sub-functional blocks. The controller unit 104a is similar to the controller unit 104 of the first embodiment, except that includes the uncertainty prediction unit 1042. The uncertainty prediction unit 1042 may be provided separately from the controller unit 104a. The uncertainty prediction unit 1042 corresponds to a first uncertainty prediction unit.

The uncertainty prediction unit 1042 predicts an aleatoric uncertainty of the data. The uncertainty prediction unit 1042 may predict the uncertainty of the data using, for example, Bayesian estimation. In a configuration in which the image recognition device 10a includes the scene classification unit 1041, the uncertainty prediction unit 1042 predicts the uncertainty of the scenes classified by the scene classification unit 1041. In this case, the uncertainty of the data is the uncertainty of the scenes classified by the scene classification unit 1041. The uncertainty of the scenes can be translated into the difficulty of classifying the scenes. When the image recognition device 10a does not require a configuration with the scene classification unit 1041, the uncertainty prediction unit 1042 can predict the uncertainty of the image recognition task performed by the detector 103 controlled by the controller unit 104a from the tendency in the content of the surrounding images.

The controller unit 104a dynamically changes the processing contents of the image recognition tasks in the detector 103 using the uncertainty of the data predicted by the uncertainty prediction unit 1042. When the scene classification unit 1041 is an essential component, the uncertainty of the scenes is used as uncertainty of data. The controller unit 104a may dynamically change the processing contents of the multiple image recognition tasks in the detector 103 according to the degree of uncertainty. The degree of uncertainty may be divided into two levels, a high level of uncertainty and a low level of uncertainty, separated by a predetermined threshold. The controller unit 104a may change the processing content of the image recognition tasks to suit the level of uncertainty. The controller unit 104a may use machine learning to learn the processing contents of the image recognition tasks that are appropriate for each level of uncertainty. According to the above configuration, it is possible to perform image recognition task processing appropriate to the uncertainty of the data. In the second embodiment, the controller unit 104a may not include the scene classification unit 1041. In this case, the uncertainty prediction unit 1042 only needs to predict the uncertainty of the data input from the image acquisition unit 101 to the controller unit 104b.

### Third Embodiment

The present disclosure is not limited to the configuration described in the above embodiment, but can also adopt the following configuration as a third embodiment. The followings will describe a configuration of the third embodiment with reference to the drawings. The image recognition system 1 of the third embodiment is similar to the image recognition system 1 of the first embodiment, except that the image recognition system 1 of the third embodiment includes an image recognition device 10b instead of the image recognition device 10.

### Schematic configuration of Image recognition device 10b

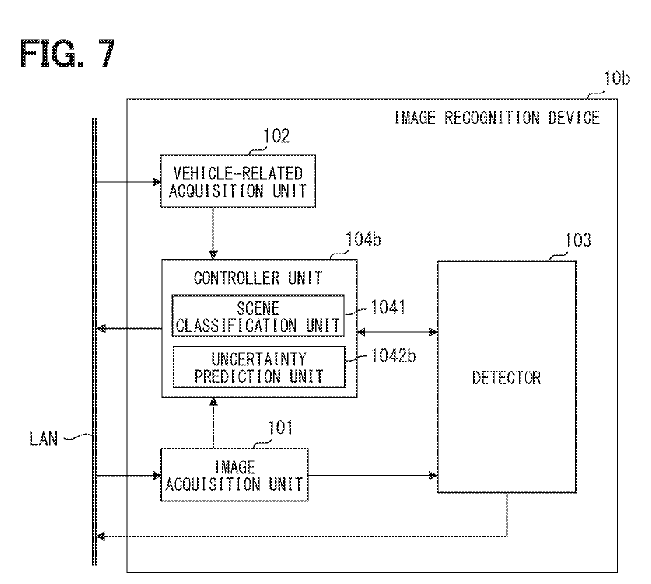

Next, the schematic configuration of the image recognition device 10b will be described with reference to FIG. 7. As shown in FIG. 7, the image recognition device 10b includes the image acquisition unit 101, the vehicle-related acquisition unit 102, the detector 103, and a controller unit 104b as functional blocks. The image recognition device 10b is similar to the image recognition device 10 of the first embodiment except that it includes the controller unit 104b instead of the controller unit 104. Furthermore, the execution of the processing of each functional block of the image recognition device 10b by a computer corresponds to the execution of an image recognition method.

The controller unit 104b has the scene classification unit 1041 and an uncertainty prediction unit 1042b as sub-functional blocks. The controller unit 104b is similar to the controller unit 104 of the first embodiment except that it includes the uncertainty prediction unit 1042b. The uncertainty prediction unit 1042b may be provided separately from the controller unit 104b. The uncertainty prediction unit 1042b corresponds to the second uncertainty prediction unit. In the third embodiment, it may not be essential that the controller unit 104b includes the scene classification unit 1041.

The uncertainty prediction unit 1042b predicts data uncertainty (Aleatoric uncertainty) and model uncertainty (Epistemic uncertainty). The uncertainty prediction unit 1042b may predict the uncertainty of the data in the same manner as the uncertainty prediction unit 1042. When the controller unit 104b includes the scene classification unit 1041, the uncertainty prediction unit 1042b may predict the uncertainty of scenes in the same manner as the uncertainty prediction unit 1042 of the second embodiment. When the controller unit 104b does not have the scene classification unit 1041, the uncertainty prediction unit 1042b only needs to predict the uncertainty of the data input from the image acquisition unit 101 to the controller unit 104b. The uncertainty prediction unit 1042b may predict the uncertainty of the model using, for example, probabilistic modeling. The model uncertainty is the uncertainty of the machine learning model of the detector 103 controlled by the controller unit 104b. For example, in this embodiment, it may be the uncertainty of semantic segmentation, traffic light detection, and branch road detection in the machine learning model for the image input from the image acquisition unit 101.

The controller unit 104b dynamically changes the processing contents of the image recognition tasks in the detector 103 using the data uncertainty and model uncertainty predicted by the uncertainty prediction unit 1042b. The controller unit 104b may dynamically change the processing contents of the image recognition tasks in the detector 103 according to the degree of uncertainty in the data and the model. The degree of uncertainty in the data and the model may be divided into two levels, one with a large level of uncertainty and the other with a small level of uncertainty, as described in the second embodiment. The controller unit 104b may change the processing contents of the multiple image recognition tasks to suit each combination of the degree of uncertainty of the data and the model. The controller unit 104a may use machine learning to learn the processing contents of the image recognition tasks that are appropriate for each combination of the degree of uncertainty of the data and the model. According to the above configuration, it is possible to perform processing of an image recognition task that is appropriate in accordance with the uncertainty of the data and the uncertainty of the model.

The uncertainty prediction unit 1042b may be configured to predict only the model uncertainty, of the data uncertainty and the model uncertainty. In this case, the controller unit 104b may be configured to dynamically change the processing contents of the multiple image recognition tasks in the detector 103 according to the degree of uncertainty in the model. This configuration also makes it possible to perform image recognition task processing appropriate to the uncertainty of the model. Examples of image recognition task processing suitable depending on the uncertainty of the model include processing that allocates more resources to the more difficult tasks among semantic segmentation, traffic light detection, and branch detection.

### Fourth Embodiment

In the above embodiments, the image recognition device 10, 10a, 10b is provided in a vehicle, but not limited to this. The image recognition device 10, 10a, 10b may be provided outside the vehicle. For example, it may be configured to be provided in a server outside the vehicle. In this case, communication between the vehicle-side system and the image recognition device 10, 10a, 10b of the server may be performed via a communication module provided in the vehicle.

### Fifth Embodiment

In the above embodiments, the image recognition device 10, 10a, 10b is used for image recognition of surrounding image captured by the peripheral monitoring camera 141 of a vehicle, but not necessarily limited to this. The image recognition device 10, 10a, 10b may be used for image recognition of surrounding images other than those captured by the peripheral monitoring camera 141 of the vehicle. For example, it may be used for image recognition of surrounding images captured by a camera on a mobile object such as a drone. Alternatively, it may be used for image recognition of surrounding images captured by cameras installed in the facility. In the above embodiments, a peripheral image is used as the image used for image recognition, but this is not necessarily limited to this. The image used for image recognition may be an image other than a peripheral image, as long as the content of the image has a tendency to be correlated with the scene.

### Sixth Embodiment

In the above embodiments, the controller unit 104, 104a, 104b controls the network structure of the detector 103 to dynamically change the processing of the image recognition tasks in accordance with the tendency in the content of the surrounding images, but this is not necessarily limited to this. For example, a configuration may be adopted in which plural detectors 103 with different processing patterns for plural image recognition tasks are prepared in advance according to a human design. The controller unit 104, 104a, 104b may be configured to dynamically change the processing of the image recognition tasks by selecting one of the detectors 103. The network structure and parameters of the detectors 103 prepared in advance may be learned at the same time as the learning of the controller unit 104 described with reference to FIG. 5.

The present disclosure is not limited to the embodiments described above, and various modifications are possible within the scope of the claims. An embodiment obtained by appropriately combining technical means disclosed in different embodiments is also included in the technical scope of the present disclosure. The control device and the control method described in the present disclosure may be implemented by a special purpose computer which includes a processor programmed to execute one or more functions executed by computer programs. Also, the device and the method therefor which have been described in the present disclosure may be also realized by a special purpose hardware logic circuit. Alternatively, the device and the method described in the present disclosure may be implemented by one or more

special purpose computers configured by a combination of a processor executing a computer program and one or more hardware logic circuits. Furthermore, the computer program may be stored on a computer-readable non-transitory tangible storage medium as instructions executed by a computer.

What is claimed is:

1. An image recognition device comprising:
an image processor capable of multitasking to execute a plurality of image recognition tasks on an image and capable of adjusting processing contents of the image recognition tasks; and
a controller configured to adjust the processing contents of the image recognition tasks in the image processor, wherein
the controller is configured to receive the image as an input and dynamically change the processing contents of the image recognition tasks in the image processor in response to a tendency of contents of the image,
the controller is configured to receive the image as an input and classify scenes indicated by the image,
the controller is configured to dynamically change the processing contents of the image recognition tasks in the image processor in response to the scenes as the tendency of contents of the image,
the controller further is configured to predict uncertainty of the scenes, and
the controller is configured to dynamically change the processing contents of the image recognition tasks in the image processor using the uncertainty.

2. An image recognition device for a vehicle comprising:
an image processor capable of multitasking to execute a plurality of image recognition tasks on an image and capable of adjusting processing contents of the image recognition tasks; and
a controller configured to adjust the processing contents of the image recognition tasks in the image processor, wherein
the controller is configured to acquire speed information related to the vehicle, other than the image, including at least a speed of the vehicle,
the controller is configured to receive the image as an input and dynamically change the processing contents of the image recognition tasks in the image processor in response to a tendency of contents of the image, and
the controller is configured to dynamically change the processing contents of the image recognition tasks in the image processor in response to the speed information of the vehicle.

3. An image recognition device for a vehicle comprising:
an image processor capable of multitasking to execute a plurality of image recognition tasks on an image and capable of adjusting processing contents of the image recognition tasks; and
a controller configured to adjust the processing contents of the image recognition tasks in the image processor, wherein
the controller is configured to acquire driver state information related to the vehicle, other than the image, including at least a state of a driver of the vehicle,
the controller is configured to receive the image as an input and dynamically change the processing contents of the image recognition tasks in the image processor in response to a tendency of contents of the image, and
the controller is configured to dynamically change the processing contents of the image recognition tasks in the image processor in response to the driver state information of the vehicle.

4. The image recognition device according to claim 1, wherein
the controller is configured to dynamically change the processing contents of the image recognition tasks in the image processor in response to the tendency of contents of the image so as to maximize each processing accuracy of the image recognition tasks relative to a given processing time constraint.

5. The image recognition device according to claim 1, wherein
the controller is configured to dynamically change the processing contents of the image recognition tasks in the image processor in response to the tendency of contents of the image so as to minimize a sum of processing speeds of the image recognition tasks relative to a given processing accuracy constraint.

6. The image recognition device according to claim 1, wherein
the controller is configured to dynamically change the processing contents of the image recognition tasks in the image processor in response to the tendency of contents of the image so as to minimize a total amount of hardware resource usage for each of the image recognition tasks relative to a given processing accuracy constraint.

7. The image recognition device according to claim 2, wherein
the controller is configured to receive the image as an input and classifies scenes indicated by the image, and
the controller is configured to dynamically change the processing contents of the image recognition tasks in the image processor in response to the scenes as the tendency of contents of the image.

8. The image recognition device according to claim 7, wherein
the controller is further configured to predict uncertainty of the scenes, and
the controller is configured to dynamically change the processing contents of the image recognition tasks in the image processor using the uncertainty.

9. The image recognition device according to claim 1, wherein
the image processor is configured to perform a multitasking process using a machine learning model,
the controller is configured to predict at least one of uncertainty regarding the image input to the controller or uncertainty of the machine learning model, and
the controller is configured to dynamically change the processing contents of the image recognition tasks in the image processor using the uncertainty.

10. The image recognition device according to claim 1, wherein
the image processor is configured to perform a multitasking process using a neural network of a machine learning model, and
the controller is configured to dynamically change the processing contents of the image recognition tasks in the image processor by changing at least one of a network structure or a parameter of the neural network.

11. The image recognition device according to claim 1, wherein
the image processor is capable of multitasking to execute a plurality of image recognition tasks on a peripheral image captured by a peripheral monitoring camera that captures an image around a vehicle, and
the controller is configured to receive the peripheral image as an input and dynamically change processing contents of the plurality of image recognition tasks in the image processor in response to a tendency of contents of the peripheral image.

12. An image recognition method executed by at least one processor, the method comprising:
an image processing step capable of multitasking to execute a plurality of image recognition tasks on an image and capable of adjusting processing contents of the image recognition tasks; and
a controller step of adjusting the processing contents of the image recognition tasks in the image processing step, wherein
in the controller step, the image is used as an input, and the processing contents of the image recognition tasks in the image processing step are dynamically changed in response to a tendency of contents of the image,
the controller step includes
a scene classification step to receive the image as an input and classify scenes indicated by the image, and
a first uncertainty prediction step to predict uncertainty of the scenes classified by the scene classification step,
the processing contents of the image recognition tasks in the image processing step is dynamically changed in response to the scenes classified by the scene classification step as the tendency of contents of the image, and
the processing contents of the image recognition tasks in the image processing step is dynamically changed using the uncertainty predicted by the first uncertainty prediction step.

13. An image recognition method executed by at least one processor for a vehicle, the method comprising:
an image processing step capable of multitasking to execute a plurality of image recognition tasks on an image and capable of adjusting processing contents of the image recognition tasks; and
a controller step of adjusting the processing contents of the image recognition tasks in the image processing step, wherein
in the controller step, the image is used as an input, and the processing contents of the image recognition tasks in the image processing step are dynamically changed in response to a tendency of contents of the image,
the controller step includes a vehicle-related acquisition step to acquire speed information related to the vehicle, other than the image, including at least a speed of the vehicle, and
in the controller step, the processing contents of the image recognition tasks in the image processing step is dynamically changed in response to the speed information of the vehicle.

14. An image recognition method executed by at least one processor for a vehicle, the method comprising:
an image processing step capable of multitasking to execute a plurality of image recognition tasks on an image and capable of adjusting processing contents of the image recognition tasks; and
a controller step of adjusting the processing contents of the image recognition tasks in the image processing step, wherein
in the controller step, the image is used as an input, and the processing contents of the image recognition tasks in the image processing step are dynamically changed in response to a tendency of contents of the image,
the controller step includes a vehicle-related acquisition step to acquire driver state information related to the vehicle, other than the image, including at least a state of a driver of the vehicle, and
in the controller step, the processing contents of the image recognition tasks in the image processing step is dynamically changed in response to the driver state information of the vehicle.
